(19) United States
(12) Patent Application Publication
(10) Pub. No.: US 2025/0117580 A1
(43) Pub. Date: Apr. 10, 2025

(54) AUTOMATED TEXT LABELING

(71) Applicant: Insight Direct USA, Inc., Chandler, AZ (US)

(72) Inventor: Madina Kamolova, Las Vegas, NV (US)

(21) Appl. No.: 18/377,916

(22) Filed: Oct. 9, 2023

(51) Int. Cl. G06F 40/279; G06N 5/022

(52) U.S. Cl. CPC G06F 40/279; G06N 5/022

(57) ABSTRACT

A method of automated labeling of text data includes receiving a first query vector and receiving a plurality of labeled reference vectors. The first query vector represents a first unlabeled text segment and each labeled reference vector corresponds to a labeled text segment of a plurality of labeled text segments and is labeled according to the corresponding labeled text segment of the plurality of labeled text segments. The method further comprises generating a first subset of reference vectors of the plurality of reference vectors by comparing the first query vector to each reference vector of the plurality of reference vectors, determining that a first label of the first subset of labeled reference vectors has a numerosity exceeding a first threshold value, and labeling the first unlabeled text segment with the first label to create a first labeled text segment.

### FIELD OF THE INVENTION

The present disclosure relates to automated text labeling and, in particular, to the automated labeling of text to create training data for training a computer-implemented machine-learning model.

### BACKGROUND

Machine learning has a wide range of applications and various machine-learning models can be trained to make predictions useful for the performance of various tasks, such as classification, value prediction, content generation, etc. Some machine learning strategies use labeled data to train a machine-learning model to make predictions. Labeled data is typically generated through manual review and label assignment by human operators, which can be time-intensive and labor-inefficient.

### SUMMARY

An example of a method of automated labeling of text data includes receiving a first query vector and receiving a plurality of labeled reference vectors. The first query vector represents a first unlabeled text segment and each labeled reference vector corresponds to a labeled text segment of a plurality of labeled text segments and is labeled according to the corresponding labeled text segment of the plurality of labeled text segments. The method further comprises generating a first subset of reference vectors of the plurality of reference vectors by comparing the first query vector to each reference vector of the plurality of reference vectors, determining that a first label of the first subset of labeled reference vectors has a numerosity exceeding a first threshold value, and labeling, subsequent to determining that the first label of the first subset of labeled reference vectors has a numerosity exceeding the first threshold value, the first unlabeled text segment with the first label to create a first labeled text segment.

An example of a system for automated text labeling includes a processor, a user interface, and at least one memory encoded with instructions that, when executed, cause the processor to receive a first query vector and receive a plurality of labeled reference vector. The first query vector represents an unlabeled text segment and each labeled reference vector corresponds to a labeled text segment of a plurality of labeled text segments and is labeled according to the corresponding labeled text segment of the plurality of labeled text segments. The instructions, when executed, further cause the processor to generate a first subset of reference vectors of the plurality of reference vectors by comparing the first query vector to each reference vector of the plurality of reference vectors, determine that a first label of the first subset of labeled reference vectors has a numerosity exceeding a first threshold value, and label, subsequent to determining that the first label of the first subset of labeled reference vectors has a numerosity exceeding the first threshold value, the first unlabeled text segment with the first label to create a first labeled text segments.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for automated text labeling.

FIG. 2 is a flow diagram of an example of a method of automated text labeling suitable for use by the system of FIG. 1

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for the automated labeling of text to create labeled training data suitable for training a computer-implemented machine learning model. More specifically, the present disclosure relates to systems and methods that leverage a small pool of labeled text data to automatedly provide label information for unlabeled text. The systems and methods disclosed herein significantly reduce the human labor associated with manual labeling for machine learning and, to that extent, significantly reduce the time and cost required to prepare data to train machine-learning models.

Preparation of labeled training data for machine learning is a time-intensive process that typically involves manual inspection and label assignment. Where text segments are used as training data, such as for training classification, prediction, and/or generative models, preparation of labeled training data can involve manual inspection of very large quantities of text data. For example, training of a classification model may involve manual inspection and classification of thousands of text strings. The manual review required to produce labeled training data requires large amounts of human labor and, accordingly, can be expensive and time-intensive. Further, as the volume of text required to be labeled increases in size, the number of errors by human operators labeling data increases. For example, a human operator may misperceive the meaning of a text segment and, consequently, misclassify the text segment or otherwise apply an incorrect or undesirable label to the text segment. Reviewing or monitoring text labeling to identify errors can also require significant human labor and, accordingly, can also be an expensive and time-intensive process.

The text labeling systems and methods described herein compare vector information generated from a relatively small quantity of manually-labeled text to vector information generated from unlabeled text, and based on this comparison assign label information to that unlabeled text. In particular, and as will be discussed in more detail subsequently, the systems and methods disclosed herein determine the similarity of a vector representative of an unlabeled text segment to a set of vectors representative of manually-labeled text segments. Vectors of the manually-labeled text segments having sufficient similarity to the vector representative of the unlabeled text segment (e.g., a similarity greater than a threshold similarity) are grouped and the numerosity of each label among that group is then determined. If the numerosity of a label is above a threshold value, that label is then applied to the unlabeled text. Text labeled in this manner can then be used to train a computer-implemented machine-learning model.

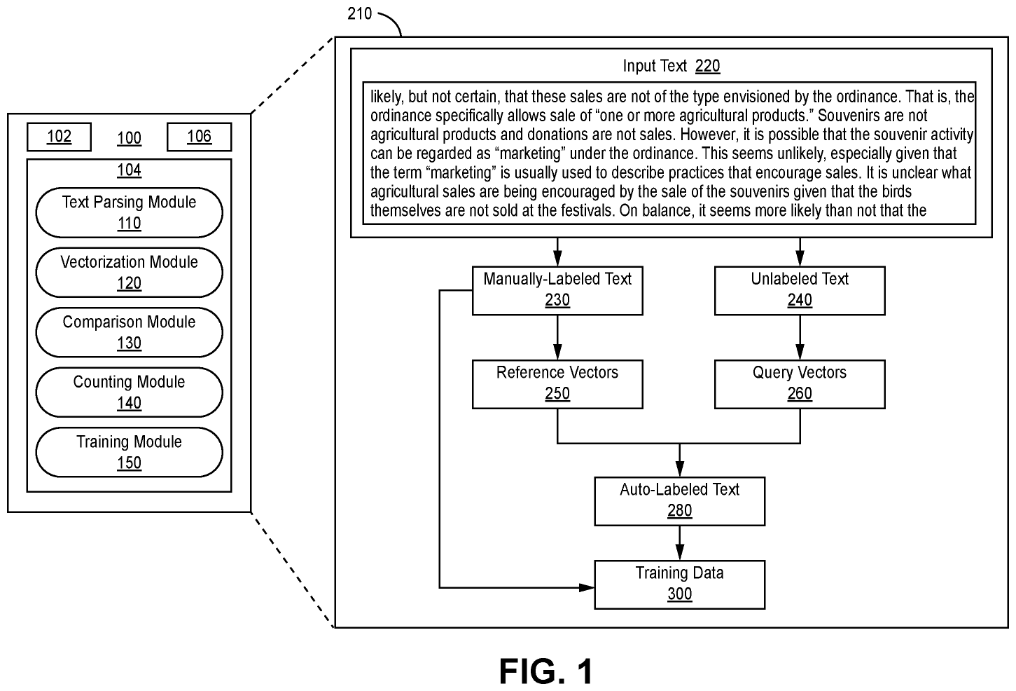

FIG. 1 is a schematic diagram of text labeling system 100, which is a computerized system for generating labeled text suitable for training a computer-implemented machine-learning model. Text labeling system 100 includes processor 102, memory 104, and user interface 106. Memory 104 includes text parsing module 110, vectorization module 120, comparison module 130, counting module 140, and training module 150. FIG. 1 also includes a schematic representation of workflow 210, which outlines the generation of training data by the modules of text labeling system 100. Workflow 210 depicts computer-mediated data transformations involving input text 220, manually-labeled text 230, unlabeled text 240, reference vectors 250, query vectors 260, auto-labeled text 280, and training data 300.

Text labeling system 100 is configured to perform automated text labeling in order to create labeled training data suitable for supervised learning of computer-implemented machine-learning models. As will be explained in more detail subsequently, text labeling system 100 compares vector information derived from unlabeled text to vector information derived from manually-labeled text (e.g., text labeled by a human operator or user) in order to automatically assign label information to the unlabeled text. Text labeling system 100 compares each unlabeled text vector to all available labeled text vectors and uses a similarity-based threshold value to identify the most similar labeled text vectors. Text labeling system 100 then counts the instances of each label of the labeled text vectors. Label(s) having a number of instances above a numerosity-based threshold value can then be assigned to the originally-unlabeled text, providing an efficient, dual-threshold approach to automatically labeling text data for supervised training. Advantageously, the dual similarity and numerosity threshold values used by the text labeling system 100 improve the granularity and accuracy with which text can be automatically labeled as compared to existing methods.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on text labeling system 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and enables an operator to control operation of text labeling system 100 and/or other components of system 10. For example, user interface 106 can be configured to receive inputs from an operator and/or provide outputs regarding text and text label information. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

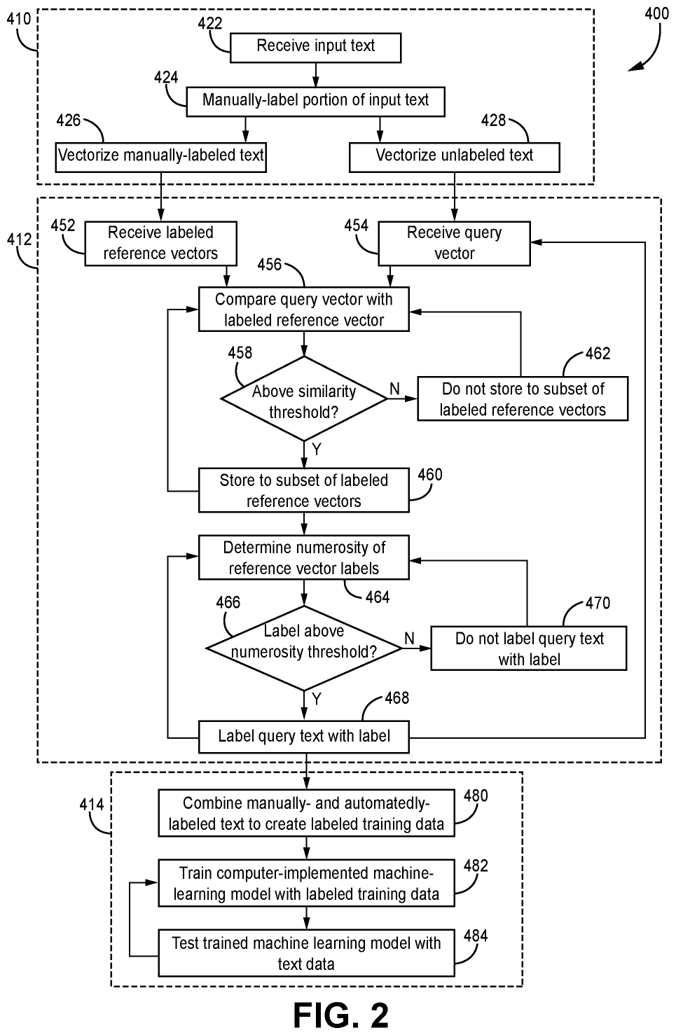

Memory 104 stores text parsing module 110, vectorization module 120, comparison module 130, counting module 140, and training module 150, each of which include one or more programs that are executable by processor 102. The functions of text parsing module 110, vectorization module 120, comparison module 130, counting module 140, and training module 150 are discussed herein with reference to workflow 210 and the text inputs, intermediates, and outputs represented therein, and in further detail with reference to FIG. 2. Workflow 210 is executed by modules 110, 120, 130, 140, and 150 in memory 104 via processor 102.

Text parsing module 110 includes one or more programs for converting input text into one or more text segments suitable for vectorization by the program(s) of vectorization module 120. More specifically, text parsing module is configured to transform input text 220 into text segments that are suitable for classification (i.e., through manual inspect and labeling or automatically by the other programs of text labeling system 100. Input text 220 can be, for example, bulk text including multiple sentences, paragraphs, etc. In these examples, text parsing module 110 can separate bulk text input into segments of a suitable size. Text parsing module 110 can separate the bulk text into, for example, individual sentences. For example, text parsing module 110 can include one or more programs for punctuating the sentences of unpunctuated bulk text, such as computer-generated transcript data, and the sentences of the bulk text can subsequently be identified and separated according to the based on the added punctuation. Parsing by the program(s) of text parsing module 110 is optional and is performed where input text 220 is not in a format, structure, etc. that is suitable for classification.

For example, text parsing module 110 can include one or more natural language processing and/or natural language understanding programs that can be used to classify the meaning (e.g., intent) of the sentences of the bulk text. Text parsing module 100 can use the meaning information to selectively extract statements that are suitable for classification. Text parsing module 110 can also include one or more programs for removing filler text or other text from input text 220 that is not suitable to include in training data for supervised learning. In at least some examples, text parsing module 110 can use one or more natural language processing and/or natural language understanding programs to identify filler text.

It may be desirable to train a computer-implemented machine-learning model to perform sentiment analysis of human-generated statements. For example, sentiment analysis of statements made in psychotherapy sessions can be used as a tool to aid mental health professionals in patient diagnosis and/or assessment. In these examples, input text 220 can be bulk transcript data of human-generated statements and text parsing module 110 can be configured to parse those transcripts to remove text that is unsuitable for classification, such as filler text, prior to initial classification of a subset of the input text. Further, text parsing module 110 can also be configured to separate bulk transcript text data into smaller segments such as individual statements and/or sentences.

As shown in the depiction of workflow 210, a portion of input text 220 is manually labeled to create manually-labeled text 230. In the most general case, manually labeled text 230 can be any set of text segments labeled prior to generation of auto-labeled text 280. As principally described herein, manually labeled text 230 is a set of text segments to which a human user has assigned one or more training labels. The remainder of input text 220 is reserved as unlabeled text 240 and lacks manually-created label information. Where input text 220 is parsed using the program(s) of text parsing module 110, a portion of the parsed text segments are classified to create manually-labeled text 230 and the remainder of the parsed text segments are reserved as unlabeled text 240. As referred to herein, the generation of “labeled” text data refers to classifying text data and providing the text data with one or more meaningful labels or tags. Data is be labeled to describe or classify the text data in a manner suitable for supervised learning by computer-implemented machine-learning models. The manually-labeled text can be labeled in any suitable manner for training a computer-implemented machine-learning model. For example, the manually-labeled text can be labeled to identify the sentiment of the text. Sentiment labels can indicate whether a statement is positive, negative, and/or neutral, among other options.

Manual classification of text to create training data is a time-intensive task that can require significant human labor. Advantageously, text labeling system 100 only requires a relatively small subset of input text 220 be manually labeled in order to automatically label the remainder of input text 220. In some examples, unlabeled text 240 can be accurately labeled using text labeling system 100 when manually-labeled text 230 is less than 50% of input text 220 (i.e., when unlabeled text 240 is greater than 50% of input text 220). In yet further examples, unlabeled text 240 can be accurately labeled when manually-labeled text is 43% or less of input text 220 (i.e., when unlabeled text 240 is 57% or more of input text 220). As a specific example, manually labeled-text 230 can include approximately 1,300 text segments that can be used to accurately label unlabeled text 240 where unlabeled text includes 1,700 or more text segments.

Vectorization module 120 includes one or more programs for vectorizing manually-labeled text 230 and unlabeled text 240 to create reference vectors 250 and query vectors 260, respectively. As used herein, “reference vectors” refer to vectors created from manually-labeled text and can include the manually-generated label information assigned to the vectorized text. Further, as used herein, “query vectors” refer to vectors created from unlabeled text. As will be explained in more detail subsequently, text labeling system 100 is able to perform automated labeling of unlabeled text by comparing a query vector (i.e., a vector representing unlabeled text) to a set or library of reference vectors (i.e., vectors represented manually-labeled text). Vectorization module 120 can use any suitable method to vectorize text, such as a word2vec method, a bag of words term frequency method, a binary term frequency method, and/or a normalized term frequency method, among other options. In all examples, manually-labeled text 230 and unlabeled text 240 are vectorized using the same method to allow meaningful comparison between reference vectors 250 and query vectors 260. Vectorization module 120 can also include one or more programs for labeling each of reference vectors 250 with the label from the corresponding manually-labeled text 230.

Comparison module 130 includes one or more programs for comparing query vectors 260 with reference vectors 250. In operation, the program(s) of comparison module 130 compare each query vector 260 to each and every reference vector 250. The reference vectors 250 having a similarity to the query vector 260 above a similarity threshold are stored to a subset of vectors that are used by the program(s) of counting module 140. Comparison module 130 can use any suitable method of determining vector similarity, such as cosine similarity and/or cartesian product, among other options. The similarity threshold can be any suitable value and can be selected based on the method used to assess vector similarity. For example, if cosine similarity is used as a measure of vector similarity, the similarity threshold can be a value between −1 and 1. In at least some examples, a cosine similarity value of 0.8 can be the similarity threshold used by comparison module 130.

Counting module 140 includes one or more programs for determining the numerosity of the subset of reference vectors 250 having a similarity greater than the similarity threshold to the relevant query vector (i.e., the query vector for which the subset of reference vectors 250 was generated by comparison module 130). In particular, the program(s) of counting module 140 determine if a particular tag or label of the subset of reference vectors 250 (or the corresponding manually-labeled text 230 represented by the subset of reference vectors 250) exceeds the numerosity threshold. For a given query vector counting module 140 can compare the numerosity of the corresponding subset of reference vectors 250 to a numerosity threshold value. If a label or tag of the subset of reference vectors 250 is above the numerosity threshold, counting module 140 or another suitable program of test labeling system 10 can assign that label or tag to the unlabeled text 240 used to generate the query vector 260 (i.e., the unlabeled text 240 corresponding to the query vectors 260). Assigning a label to unlabeled text 240 in this manner generates auto-labeled text 280. Text labeling system 100 then recombines auto-labeled text 280 with manually-labeled text 230 to create training data 300. Training data 300 is labeled text data suitable for training a computer-implemented machine-learning model.

Advantageously, the combination of the programs of comparison module 130 and counting module 140 allows text labeling system 100 to automatically generate label or tag information based on manually-created labels for a subset of text. Further, the dual-threshold process (i.e., the use of both a comparison threshold and a numerosity threshold) significantly improves the accuracy with which text labeling system 100 can automatically label text. Advantageously, improving the accuracy of the labels of auto-labeled text 280 provides concomitant improvements to the accuracy of classifications made by a computer-implemented machine-learning model trained using auto-labeled text 280.

Training module 150 includes one or more programs for training a computer implemented machine learning model using training data 300. Training module 150 is configured to train a computer-implemented machine-learning model stored to memory 104 and/or another suitable memory device using training data 300 generated from input text 210 using the program(s) of comparison module 130 and counting module 140. Training module 150 is generally configured to train a classification model using a supervised learning approach, but can be configured to train any suitable model on training data 300 using any suitable machine learning approach. The machine learning model trained using training module 150 can be, for example, a linear regression model, a gradient boosting model, a support vector machine, a random forest model, an artificial neural network, a deep learning model, and/or a transformer model, among other options.

Advantageously, text labeling system 100 significantly reduces the labor required to accurately label text to create training data suitable for training a computer-implemented machine learning model. As described previously, text labeling system 100 is able to accurately label or tag text segments of a pool or population of text segments (e.g., all text segments derived from an input text 220) when only a subset of that pool or population of text segments has been labeled manually (e.g., by a human operator). Text labeling system 100 can accurately and automatedly label unlabeled text when less than half of a pool or population of text segments have been manually labeled and, in some examples, when less than 43% of text segments have been manually labeled.

FIG. 2 is a flow diagram of method 400, which is a method of automated text labeling suitable for use by text labeling system 100 and includes sub-methods 410, 412, 414. Sub-method 410 is a method of processing input text into vector information and includes steps 422-428 of receiving input text (step 422) received as or convertible into a set of text segments, manually-labeling a portion of the input text segments to create a manually-labeled portion of the text segments (step 424), vectorizing the manually-labeled portion of text segments (step 426), and vectorizing the unlabeled portion of text segments (step 428). Sub-method 412 is a method of automatedly labeling unlabeled text using vector information and includes steps 452-468 of receiving labeled reference vectors (step 452), receiving a query vector (step 454), comparing the query vector of each text segment with a labeled reference vector (step 456), determining whether the similarity of the query vector and the labeled reference vector is above a similarity threshold (step 458), storing or not storing the labeled reference vector to a subset of labeled reference vectors (step 460 and step 462, respectively), determining a numerosity of reference vector labels (step 464), determining whether the label is above a numerosity threshold (step 466), and labeling or not labeling the query text segment with the label (step 468 and step 470, respectively). Following step 468, method 400 proceeds to step 480, in which the manually- and automatedly-labeled text segments are used to train a computer-implemented machine-learning model. Sub-method 414 is a method of using the manually- and automatedly-labeled text segments to train a computer-implemented machine learning model and includes steps of combining the manually- and automatedly-labeled text segments to create labeled training data (step 480) and training a computer-implemented machine-learning model with the labeled training data (step 482). For explanatory purposes, method 400 is generally described herein with reference to text labeling system 100 and the components thereof. However, it is understood that method 400 can be performed using any suitable automated and/or computerized system.

In step 422, input text is received. The input text is be received by text labeling system 100 and can be stored to memory 104 for use with subsequent steps of method 400. System 100 can separate the input text received in step 422 into one or more text segments, such as sentences, subsentences, ideas, paragraphs, etc. Additionally and/or alternatively, system 100 can receive the input text as one or more text segments.

In step 424, a portion of the input text (i.e., a portion of the received plurality of text segments) is manually-labeled. System 100 and/or a human operator can designate an amount and/or a percentage of the input text segments for manual labeling. For example, less than 50% (and in some examples, an amount less than or equal to 43%) of the input text segments as for labeling by a human operator. A human operator manually labels each text segment designated for manual labeling by manually inspecting and assigning label information. The label information assigned in step 424 is label information suitable for training a computer-implemented machine-learning model. For example, the label information can be sentiment information (e.g., whether a text segment is positive, negative, or neutral) suitable for training a sentiment classifier.

In step 426, the manually-labeled text segments (i.e., the text labeled in step 424) are vectorized. In step 428, the unlabeled text segments (i.e., text segments constituting the remainder of the input text received in step 422) are vectorized. Steps 426, 428 can be performed in any suitable order and, in at least some examples, can be performed simultaneously or substantially simultaneously. Further, in some examples, step 426 and/or step 428 can be performed prior to or substantially simultaneously as step 424. Steps 426, 428 can be performed using any suitable text vectorization method, such as a word2vec method, a bag of words term frequency method, a binary term frequency method, and/or a normalized term frequency method, among other options. Steps 426, 428 are performed using the same vectorization method such that the resultant reference and query vectors are able to be compared in subsequent steps 456, 458. The vectors created in steps 426 and 428 are referred to herein as reference vectors and query vectors, respectively. The vectors created in steps 426, 428 can be stored to memory 104 or another suitable memory or storage device for use with the steps of sub-method 412.

In step 452, the reference vectors created in step 426 are received. In step 454, one query vector of the query vectors created in step 428 is received. The reference vector and query vector can be received from a device or program module that created the reference and query vectors. Additionally and/or alternatively, the reference vectors and query vector can be received by, for example, recalling the reference vectors and query vector from a memory, such as memory 104 or another memory or storage device to which the reference vectors and/or query vector(s) are stored. The reference vectors received in step 452 can be referred to as “labeled vectors” or “labeled reference vectors,” as they describe manually-labeled text segments. In at least some examples, each reference vector can be encoded or associated with the label of the manually-labeled text segment used to create the reference vector.

In step 456, the query vector is compared to a reference vector of the reference vectors received in step 452. The query vector can be compared to the reference vector using any suitable technique and, in at least some examples, the query vector and reference vector are compared by cosine similarity or cartesian product. Step 456 generates a numeric value representative of the similarity between the query vector and the reference vector.

In step 458, the numeric value generated in step 456 is compared to a similarity threshold. The similarity threshold can be stored to memory 104 or another suitable memory or storage device and recalled and/or retrieved for use with step 458. If the numeric similarity value is greater than the similarity threshold, method 400 proceeds to step 460. Conversely, if the numeric similarity value is less than the similarity threshold, method 400 proceeds to step 462. Although the comparison performed in step 458 is described generally herein as determining whether the numeric similarity value is “greater than” or “less than” the similarity threshold, it is understood that “less than” can refer to logic that requires the value be “less than” or “less than or equal to” the threshold, and further that “greater than” can refer to logic that requires the value be “greater than” or “greater than or equal to” the threshold. Text labeling system 100 or another device performing method 400 can be configured with any appropriate comparison logic (i.e., greater than, greater than or equal to, less than, less than or equal to, etc.) to perform step 458.

The similarity threshold can be any suitable value and can be selected at least in part based on the method used to assess vector similarity. The similarity threshold can also be selected to adjust the specificity and/or sensitivity of method 400. For example, if cosine similarity is used as a measure of vector similarity, the similarity threshold can be a value between −1 and 1. In at least some examples, a cosine similarity value of 0.8 can be the similarity threshold used by comparison module 130.

In step 460, the reference vector is stored to a subset of labeled reference vectors 460. The subset of reference vectors includes only vectors having a similarity to the query vector above the threshold value and can be used by text labeling system 100 to perform subsequent steps 464, 466. In step 460, text labeling system 100 can store the reference vector to by, for example, by storing an identifier (e.g., a file name, etc.) corresponding to the reference vector. Additionally and/or alternatively, text labeling system 100 can be configured to create a copy of the reference vector that can be recalled as part of the subset of reference vectors for use with steps 464-466. In step 462, the reference vector is not stored to the subset of labeled reference vectors. In some examples, step 460 does not require storing a copy of the reference vector, but rather only requires storing the label(s) associated with the reference vector. In these examples, the subset created in step 460 can include only label information and can omit vector information.

Steps 456-462 are repeated to compare the query vector to each reference vector received in step 452. The query vector can be compared iteratively, sequentially, in parallel, and/or any combination thereof with each reference vector such that the query vector is compared to all query vectors.

After the query vector has been compared to all reference vectors to complete the subset of reference vectors, method 400 proceeds to step 464. In step 464, text labeling system 100 determines the numerosity of the labels of the reference vectors of the subset created in steps 456-462. More specifically, text labeling system 100 counts the instances of each label of the labeled reference vectors in step 464. Text labeling system 100 can, for example, count label information for each reference vector in examples where the reference vectors are encoded or associated with labels. Additionally and/or alternatively, text labeling system 100 can retrieve label information from the labeled text segments represented by the reference vectors to determine numerosity in step 464.

In step 466, text labeling system 100 compares each numerosity value (i.e. the numerosity of each label) to a numerosity threshold. If the numerosity of the label is greater than the numerosity threshold, method 400 proceeds to step 468. In step 468, the label is assigned to the unlabeled text segment represented by the query vector. If the numerosity of the label is less than the numerosity threshold, method 400 proceeds to step 470. In step 470, the label is not assigned to the unlabeled text segment. Although the comparison performed in step 466 is described generally herein as determining whether the numeric similarity value is “greater than” or “less than” the similarity threshold, it is understood that “less than” can refer to logic that requires the value be “less than” or “less than or equal to” the threshold, and further that “greater than” can refer to logic that requires the value be “greater than” or “greater than or equal to” the threshold. Steps 464-468 can be repeated for each unique label appearing in the subset of labeled reference vectors created in steps 456-460. The numerosity threshold used in step 466 can be any suitable value and can be selected to adjust the specificity and/or sensitivity of method 400. For example, the numerosity threshold can require that 8 instances of a particular label to assign that label to the unlabeled text segment corresponding to the query vector.

In some examples, additional logic can be used to apply a label to the unlabeled text represented by the query vector. For example, text labeling system 100 can be configured to assign the unlabeled text segment with only the label having the greatest numerosity. As another example, text labeling system 100 can be configured to assign the unlabeled text with a particular number of labels having the greatest numerosity. Further, if no label has a numerosity above the numerosity threshold, text labeling system 100 can be configured to assign no label to the unlabeled text segment and to flag the unlabeled text segment for manual review and labeling by a human operator.

After the text segment represented by the query vector is labeled using steps 456-468, method 400 proceeds back to step 454 to assign label information to another unlabeled text segment represented by another query vector. Method 400 can repeat steps 454-468 for all query vectors created in step 428 to label all unlabeled text segment (i.e., all of the input text received in step 422 that was not labeled in step 424). Each iteration of steps 456-468 can be performed sequentially, in parallel, and/or in any suitable order. Accordingly, steps 454-468 of sub-method 412 can be used to automatedly label text segments based on a manually-labeled portion or subset of the input text received in step 422. Text segments labeled according to steps 454-468 of sub-method 412 are referred to herein as “automatedly-labeled text” or “automatedly-labeled text segments.

In some examples, the manually-labeled text segments (i.e., the text segments labeled in step 424) can include multiple labels. The labels can describe, for example, multiple aspects of the text segments. In these examples, steps 464-468 can be performed in parallel, sequentially, iteratively, etc. for each label of the reference vector in the subset of vectors created according to steps 456-462.

In step 480, text labeling system 100 combines the manually-labeled text segments (i.e. the text segments labeled in step 424) and the automatedly-labeled text segments (i.e., the text labeled in an automated manner according to sub-method 412) to create labeled training data that can be used to train a computer implemented machine learning model. The labeled training data created in step 480 includes the text segment data vectorized in steps 426, 428 and labels manually- and automatedly-assigned according to method 400.

In step 482, the labeled training data is used to train a computer-implemented machine-learning model. The computer-implemented machine-learning model can be any suitable machine-learning model for supervised training. Generally, a supervised learning strategy is used to train the computer-implemented machine-learning model in step 482, but any suitable learning strategy can be used. As used herein, “training” a computer-implemented machine-learning model refers to any process by which parameters, hyper parameters, weights, and/or any other value related model accuracy are adjusted to improve the fit of the computer-implemented machine-learning model to the training data.

In step 484, the trained computer-implemented machine-learning model is tested with test data. Accordingly, the test data is unlabeled data of substantially the same type as the data used in step 482 and can be used to qualify and/or quantify performance of the trained computer-implemented machine-learning model. More specifically, a human or machine operator can evaluate the performance of the machine-learning model by evaluating the fit of the model to the test data. Step 484 can be used to determine, for example, whether the machine-learning model was overfit to the labeled data during model training in step 482.

Subsequent to step 484, the computer-implemented machine-learning model can analyze new data to classify that data, make predictions regarding that data, etc. For example, if the training data produced using steps 422-480 of method 400 describes text sentiment, the computer-implemented machine-learning model can be used to classify the sentiment of new text (i.e., text that is not part of the input text received in step 422).

Notably, sub-methods 410, 412, 414 can be performed independently of and do not require the performance of the other sub-methods of method 400. For example, sub-method 412 can be performed to label text based on vectors created from labeled text segments (i.e., the reference vectors received in step 452) and vectors created from unlabeled text segments (i.e., query vectors received in step 454). Sub-method 410 can be used to create vectors of manually-labeled and unlabeled text, and sub-method 414 can be used to train a machine learning method independently of the performance of the other elements of method 400. In at least some examples, sub-methods 412, 414 can be performed using pre-generated reference vectors and new query vectors prepared as described previously with respect to step 428 of method 400.

Advantageously, method 400 can be performed in an automated or partially automated manner by text labeling system 100 or any other suitable device. Accordingly, method 400 and, in particular, sub-method 412 significantly reduce human labor required to accurately label text to create training data suitable for training a computer-implemented machine learning model. Method 400 and, in particular, sub-method 412 also significantly reduce the time required to produce training data for training a computer-implemented machine-learning model. The use of both similarity and numerosity improves the accuracy with which method 400 can be used to recognize and assign labels to unlabeled text as compared to existing methods. Further, the use of separate thresholds for similarity and numerosity (i.e., the thresholds used in step 458 and step 466, respectively) improves the granularity with which method 400 can exclude or include unlabeled text segments in a particular labeled class or category by allowing two points in the label-generation process at which to adjust the specificity and/or sensitivity of the automated assignment of text label information.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automated labeling of text data, the method comprising:
receiving a first query vector, the first query vector representing a first unlabeled text segment;
receiving a plurality of labeled reference vectors, each labeled reference vector corresponding to a labeled text segment of a plurality of labeled text segments, wherein each labeled reference vector is labeled according to the corresponding labeled text segment of the plurality of labeled text segments;
generating a first subset of reference vectors of the plurality of reference vectors by comparing the first query vector to each reference vector of the plurality of reference vectors;
determining that a first label of the first subset of labeled reference vectors has a numerosity exceeding a first threshold value; and
labeling, subsequent to determining that the first label of the first subset of labeled reference vectors has a numerosity exceeding the first threshold value, the first unlabeled text segment with the first label to create a first labeled text segment.

2. The method of claim 1, and further comprising generating the plurality of labeled reference vectors from the plurality of labeled text segments by vectorizing the plurality of labeled text segments.

3. The method of claim 2, and further comprising generating the first query vector by vectorizing the first unlabeled text segment.

4. The method of claim 3, and further comprising:
receiving a plurality of input text segments; and
manually labeling a portion of the plurality of input text segments to create the plurality of labeled text segments;
wherein a remainder of the plurality of input text segments comprises the first unlabeled text segment.

5. The method of claim 4, wherein:
the remainder of the plurality of input text segments comprises a plurality of unlabeled text segments; and
the plurality of unlabeled text segments comprises the first unlabeled text segment.

6. The method of claim 5, wherein the portion of the plurality of input text segments comprises less than half of the plurality of input text segments.

7. The method of claim 6, wherein:
comparing the first query vector to each reference vector of the plurality of reference vectors comprises determining whether the first query vector has a similarity greater than a second threshold value to each reference vector of the plurality of reference vectors; and
generating the first subset of reference vectors comprises storing, to the first subset of reference vectors, the reference vectors of the plurality of reference vectors having a similarity above the second threshold value to the first query vector.

8. The method of claim 7, wherein comparing the first query vector to each reference vector of the plurality of reference vectors comprises generating a plurality of cosine similarity scores, each cosine similarity score of the plurality of cosine similarity scores describing a similarity between the first query vector and one reference vector of the plurality of reference vectors.

9. The method of claim 8, wherein the second threshold value is a cosine similarity score of 0.8.

10. The method of claim 6, wherein comparing the first query vector to each reference vector of the plurality of reference vectors comprises generating a plurality of cartesian products, each cartesian product of the plurality of cartesian products describing a similarity between the first query vector and one reference vector of the plurality of reference vectors.

11. The method of claim 5, and further comprising:
generating a plurality of query vectors from the unlabeled text segments of the plurality of unlabeled text segments other than the first unlabeled text segment; and
labeling the plurality of unlabeled text segments to generate a plurality of machine-labeled text segments by, for each query vector of the plurality of query vectors:
generating a subset of reference vectors of the plurality of reference vectors by comparing the query vector to each reference vector of the plurality of reference vectors;
determining that a label of the subset of labeled reference vectors has a numerosity exceeding the first threshold value; and
labeling with the label, subsequent to determining that the label of the subset of labeled reference vectors has a numerosity exceeding the first threshold value, the unlabeled text of the plurality of unlabeled text corresponding to query vector.

12. The method of claim 11, and further comprising:
combining the plurality of machine-labeled text segments, the first labeled text segments, and the plurality of labeled text segments to create labeled training data;
training a computer implemented machine learning model with the labeled training data.

13. The method of claim 1, wherein the first threshold value is a numerosity of 8.

14. The method of claim 1, and further comprising determining that a second label of the subset of labeled reference vectors has a numerosity that does not exceed the first threshold value.

15. A method comprising:
receiving a plurality of query vectors, each query vector representing an unlabeled text segment of a plurality of unlabeled text segments;
receiving a plurality of labeled reference vectors, each labeled reference vector:
corresponding to a labeled text segment of a plurality of labeled text segments; and
labeled according to the corresponding labeled text segment of the plurality of labeled text segments; and
labeling the plurality of unlabeled text segments to generate a plurality of machine-labeled text segments by, for each query vector of the plurality of query vectors:
generating a subset of reference vectors of the plurality of reference vectors by comparing the query vector to each reference vector of the plurality of reference vectors;
determining that a label of the subset of labeled reference vectors has a numerosity exceeding the first threshold value; and
labeling with the label, subsequent to determining that the label of the subset of labeled reference vectors has a numerosity exceeding the first threshold value, the unlabeled text segment of the plurality of unlabeled text segments corresponding to query vector.

16. The method of claim 15, and further comprising:
combining the plurality of labeled text segments and the plurality of machine-labeled text segments to create labeled training data; and
training a computer-implemented machine learning model using the labeled training data.

17. A system for automated text labeling, the system comprising:
a processor;
a user interface; and
at least one memory encoded with instructions that, when executed, cause the processor to:
receive a first query vector, the first query vector representing a first unlabeled text segment;
receive a plurality of labeled reference vectors, each labeled reference vector:
corresponding to a labeled text segment of a plurality of labeled text segments; and
labeled according to the corresponding labeled text segment of the plurality of labeled text segments;
generate a first subset of reference vectors of the plurality of reference vectors by comparing the first query vector to each reference vector of the plurality of reference vectors;
determine that a first label of the first subset of labeled reference vectors has a numerosity exceeding a first threshold value; and
label, subsequent to determining that the first label of the first subset of labeled reference vectors has a numerosity exceeding the first threshold value, the first unlabeled text segment with the first label to create a first labeled text segments.

18. The system of claim 17, wherein the instructions, when executed, further cause the processor to:
receiving a plurality of input text segments; and
receive labeling input from the user interface, the labeling input assigning labels to a portion of the plurality of input text segments to create the plurality of labeled text segments;
wherein a remainder of the plurality of input text segments comprises the first unlabeled text segment.

19. The system of claim 18, wherein:
the remainder of the plurality of input text segments comprises a plurality of unlabeled text segments; and
the plurality of unlabeled text segments comprises the first unlabeled text segment.

20. The system of claim 19, wherein the instructions, when executed, further cause the processor to:
compare the first query vector to each reference vector of the plurality of reference vectors by determining whether the first query vector has a similarity above a second threshold value to each reference vector of the plurality of reference vectors; and
generate the first subset of reference vectors by storing, to the first subset of reference vectors, the reference vectors of the plurality of reference vectors having a similarity above the second threshold value to the first query vector.
